(19) United States
(12) Patent Application Publication
(10) Pub. No.: US 2026/0168696 A1
(43) Pub. Date: Jun. 18, 2026

(54) POWER SAVING SYSTEM, POWER SAVING DEVICE, AIR CONDITIONER CONTROL METHOD, AND RECORDING MEDIUM

(71) Applicant: Mitsubishi Electric Corporation, Chiyoda-ku, Tokyo (JP)

(72) Inventor: Hajime IKEDA, Chiyoda-ku, Tokyo (JP)

(73) Assignee: Mitsubishi Electric Corporation, Chiyoda-ku, Tokyo (JP)

(21) Appl. No.: 19/117,437

(22) PCT Filed: Nov. 9, 2023
(86) PCT No.: PCT/JP2023/040452

§ 371 Date: Apr. 1, 2025

(30) Foreign Application Priority Data
Dec. 7, 2022 (JP) 2022-195413

(51) Int. Cl. F24F 11/88; G05B 13/04

(52) U.S. Cl. CPC F24F 11/88; G05B 13/048

(57) ABSTRACT

A power saving device causes an air conditioner to perform a power saving operation. The power saving device includes a normal charge calculator to predict power consumption based on information indicating an operating state acquired by an operating state acquirer and calculate a normal charge based on the predicted power consumption and a trend of an electric rate predicted by an electric rate predictor, and a saving charge calculator to predict, based on the acquired information indicating the operating state, saving power-consumption in a power saving mode and calculate a saving charge based on the predicted saving power-consumption and the trend of the electric rate predicted by the electric rate predictor.

### TECHNICAL FIELD

The present disclosure relates to a power saving system, a power saving device, an air conditioner control method, and a program.

### BACKGROUND ART

A power saving system manages the power of electric installations or electric devices for, for example, households or businesses. Some power saving systems save power by managing the operations of air conditioners that use a large ratio of power consumed by, for example, households or businesses.

For example, Patent Literature 1 describes a power saving device that calculates an electric charge for power consumed by an air conditioner for a predetermined period based on information indicating an electric rate. This power saving device evaluates the operation of the air conditioner based on the comfortability for a predetermined period determined by the calculated electric charge and the operating state of the air conditioner and determines the operating state in which the evaluation value is optimum. The power saving device thus saves power while maintaining air-conditioning comfortability.

### CITATION LIST

### Patent Literature

Patent Literature 1: Unexamined Japanese Patent Application Publication No. 2018-40510

### SUMMARY OF INVENTION

### Technical Problem

Electricity retailing may change the electric rate based on the demand for electricity. When receiving power supply from a retailing electric utility, the power saving device described in Patent Literature 1 using a predetermined rate as information indicating the electric rate cannot sufficiently respond to a change in the electric rate.

In response to the above issue, an objective of the present disclosure is to provide a power saving system, a power saving device, an air conditioner control method, and a program that can sufficiently manage power saving for any change in an electric rate based on the demand for electricity.

### Solution to Problem

To achieve the above objective, a power saving system according to an aspect of the present disclosure includes an air conditioner and a control device to manage power saving by causing the air conditioner to perform a power saving operation. The control device includes an electric rate acquirer, an electric rate predictor, an operating state acquirer, a normal charge calculator, a saving charge calculator, a determiner, and an air conditioning controller. The electric rate acquirer acquires information indicating an electric rate for a predetermined period including a current time. The electric rate predictor predicts, based on the information indicating the electric rate for the predetermined period acquired by the electric rate acquirer, a trend of an electric rate for a prediction period from the current time. The operating state acquirer acquires, from a controller included in the air conditioner, information indicating an operating state of each component included in the air conditioner. The normal charge calculator predicts power consumption of the air conditioner based on the information indicating the operating state acquired by the operating state acquirer and calculates, based on the predicted power consumption and the trend of the electric rate predicted by the electric rate predictor, a normal charge for the air conditioner operated in the operating state for the prediction period. The saving charge calculator predicts, based on the information indicating the operating state acquired by the operating state acquirer, saving power-consumption for the air conditioner operated in a power saving mode and calculates, based on the predicted saving power-consumption and the trend of the electric rate predicted by the electric rate predictor, a saving charge for the air conditioner operated in the power saving mode for the prediction period. The determiner calculates, based on the normal charge calculated by the normal charge calculator and the saving charge calculated by the saving charge calculator, an amount reduced by power saving and determines, when the calculated amount exceeds a set amount, that the power saving operation is to be performed. The air conditioning controller operates, when the determiner determines that the power saving operation is to be performed, each component in the air conditioner in the power saving mode.

### Advantageous Effects of Invention

In the structure according to the aspect of the present disclosure, the electric rate predictor predicts the trend of the electric rate for the prediction period from the current time, and the normal charge calculator and the saving charge calculator calculate the normal charge and the saving charge based on the predicted trend of the electric rate. The determiner calculates the amount reduced by power saving based on the calculated normal charge and saving charge and determines, when the calculated amount exceeds the set amount, that the power saving operation is to be performed. The power saving system can thus effectively save power when the electric rate changes based on the demand for electricity by determining whether the amount reduced by power saving exceeds the set amount. The power saving system can thus manage power saving sufficiently.

### BRIEF DESCRIPTION OF DRAWINGS

FIG. 1 is a diagram of a refrigerant circuit in an air conditioner included in a power saving system according to an embodiment of the present disclosure;

FIG. 2 is a p-h diagram illustrating the refrigerant state in the air conditioner included in the power saving system according to the embodiment of the present disclosure;

FIG. 3 is a diagram of the power saving system according to the embodiment of the present disclosure, illustrating the hardware configuration;

FIG. 4 is a block diagram of the power saving system according to the embodiment of the present disclosure;

FIG. 5 is a table of an example of electric rate information used in the power saving system according to the embodiment of the present disclosure;

FIG. 6 is a table of an example of power consumption information used in the power saving system according to the embodiment of the present disclosure;

FIG. 7 is a table of an example of saving information used in the power saving system according to the embodiment of the present disclosure;

FIG. 8 is a flowchart of a power saving process performed by a power saving device included in the power saving system according to the embodiment of the present disclosure; and

FIG. 9 is a flowchart of a superheat control process performed by a controller in the air conditioner included in the power saving system according to the embodiment of the present disclosure.

### DESCRIPTION OF EMBODIMENTS

A power saving system, a power saving device, an air conditioner control method, and a program according to an embodiment of the present disclosure are now described in detail with reference to the drawings. Like reference signs denote like or corresponding components in the drawings.

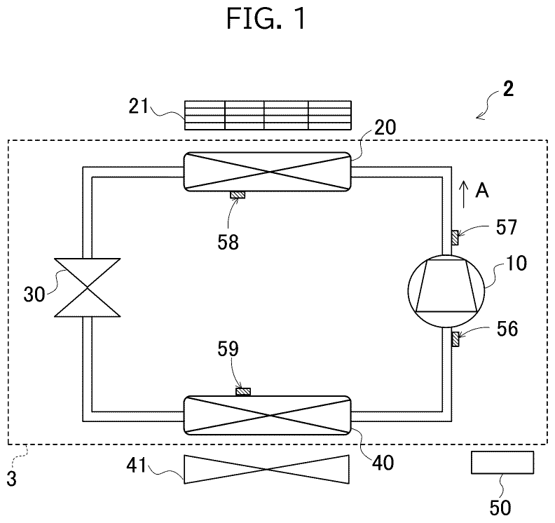

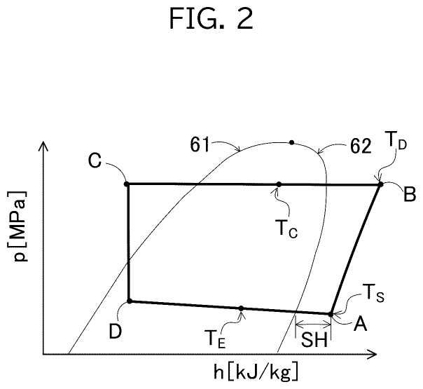

The power saving system according to the embodiment saves power by operating an air conditioner with superheat control for causing superheat to be 0° C. With reference to FIGS. 1 and 2, the structure of the air conditioner and the superheat control are described. The superheat control is hereafter referred to as SH control.

FIG. 1 is a diagram of a refrigerant circuit in an air conditioner 2 included in the power saving system according to the embodiment. For ease of understanding, FIG. 1 does not illustrate a four-way valve. The flow of a refrigerant during a heating operation is indicated by arrow A.

As illustrated in FIG. 1, the air conditioner 2 includes a compressor 10 that compresses the refrigerant, an indoor heat exchanger 20 that causes heat exchange between the refrigerant and indoor air, an expansion valve 30 that expands the refrigerant, and an outdoor heat exchanger 40 that causes heat exchange between the refrigerant and outside air. The compressor 10, the indoor heat exchanger 20, the expansion valve 30, and the outdoor heat exchanger 40 are connected in this order to form a refrigerant circuit 3.

The compressor 10 compresses a low-pressure refrigerant into a high-pressure refrigerant. The compressor 10 has an inlet port and an outlet port, which are not illustrated, and sucks a low-pressure refrigerant through the inlet port. The compressor 10 then compresses the refrigerant into a high-pressure refrigerant. The compressor 10 is electrically connected to a controller 50. The pressure of the refrigerant is thus determined by an instruction from the controller 50 to the compressor 10. The compressor 10 discharges the high-pressure refrigerant through the outlet port.

The inlet port and the outlet port, which are not illustrated, in the compressor 10 are connected to a non-illustrated four-way valve. The indoor heat exchanger 20 and the outdoor heat exchanger 40 are connected to the four-way valve with a refrigerant pipe. The controller 50 illustrated in FIG. 1 is electrically connected to the four-way valve. Thus, the four-way valve allows, as controlled by the controller 50, the refrigerant in either the indoor heat exchanger 20 or the outdoor heat exchanger 40 to flow to the inlet port in the compressor 10. The four-way valve further allows the high-pressure refrigerant discharged through the outlet port in the compressor 10 to flow to the other of the indoor heat exchanger 20 and the outdoor heat exchanger 40. In this manner, the four-way valve switches the direction in which the refrigerant in the refrigerant circuit 3 flows. The four-way valve thus switches the operation mode of the air conditioner 2 to either a cooling operation mode or a heating operation mode.

The compressor 10 supplies the refrigerant to the indoor heat exchanger 20 as indicated by arrow A in FIG. 1 by switching the four-way valve. The air conditioner 2 performs a cooling operation and a heating operation. The direction of arrow A indicates the direction in which the refrigerant flows when the air conditioner 2 is in the heating operation mode. For ease of understanding, the components in the air conditioner 2 in the heating operation mode are described.

The indoor heat exchanger 20 is, for example, a fin and tube heat exchanger. The indoor heat exchanger 20 causes heat exchange between indoor air and the refrigerant flowing through tubes. More specifically, the indoor heat exchanger 20 includes non-illustrated tubes to which the high-pressure refrigerant compressed by the compressor 10 is supplied. The indoor heat exchanger 20 also includes non-illustrated fins to which indoor air is blown by a fan 21. The rotational speed of the fan 21 is controlled by the controller 50. The indoor heat exchanger 20 causes heat exchange between the refrigerant flowing through the tubes and the indoor air blown to the fins, dissipating heat to the indoor air to condense the refrigerant. The indoor heat exchanger thus functions as a condenser. The indoor heat exchanger 20 heats the indoor air. The indoor heat exchanger 20 thus heats the indoor space. The indoor heat exchanger 20 discharges the condensed refrigerant to the expansion valve 30.

The expansion valve 30 is, for example, an electromagnetic valve or an electric-operated valve. The expansion valve 30 includes a valve element. The expansion valve 30 opens or closes the channel for the refrigerant with the valve element. The controller 50 is electrically connected to the expansion valve 30. The degree of opening of the channel with the valve element is controlled by an output from the controller 50. The refrigerant is decompressed based on the degree of opening of the channel. The expansion valve 30 decompresses the refrigerant based on the output from the controller 50 to expand the refrigerant. The expansion valve 30 supplies the expanded refrigerant to the outdoor heat exchanger 40.

Similarly to the indoor heat exchanger 20, the outdoor heat exchanger 40 is, for example, a fin and tube heat exchanger. The outdoor heat exchanger 40 causes heat exchange between outside air taken in from the outside and the refrigerant flowing through the tubes. More specifically, the outdoor heat exchanger 40 includes non-illustrated tubes through which the refrigerant expanded by the expansion valve 30 flows. The outdoor heat exchanger 40 further includes non-illustrated fins to which the outside air is blown by a fan 41. The rotational speed of the fan 41 is controlled by the controller 50. Thus, the indoor heat exchanger 20 causes heat exchange between the refrigerant flowing through the tubes and the outside air blown to the fins to evaporate the refrigerant. The outdoor heat exchanger 40 functions as an evaporator. The outdoor heat exchanger 40 directs the evaporated refrigerant to the compressor 10.

In the manner described above, the air conditioner 2 performs the heating operation to heat the indoor air by switching the four-way valve. The state of the refrigerant in the heating operation is illustrated in FIG. 2.

FIG. 2 is a p-h diagram illustrating the refrigerant state in the air conditioner 2. In FIG. 2, the horizontal axis indicates the enthalpy of the refrigerant, and the vertical axis indicates the pressure of the refrigerant. For ease of understanding, FIG. 2 indicates a saturation liquid line 61 and a saturation vapor line 62.

The refrigerant is first compressed by the compressor 10 to be a high-pressure high-temperature gas as indicated by the line from point A to point B in FIG. 2 and flows into the indoor heat exchanger 20. The refrigerant that has flowed into the indoor heat exchanger 20 is condensed to be in a single liquid phase from a gas phase, as indicated by the line from point B to point C in FIG. 2. The refrigerant in the single liquid phase then flows into the expansion valve 30 and is expanded to be in a low-pressure gas-liquid two-phase from the single liquid phase, as indicated by the line from point C to point D in FIG. 2. The low-pressure refrigerant is thus supplied to the outdoor heat exchanger 40. In the outdoor heat exchanger 40, the refrigerant exchanges heat with outside air and is decompressed. Thus, the refrigerant enters a gas phase from the gas-liquid two-phase and flows into the compressor 10, as indicated by the line from point D to point A in FIG. 2.

In such state changes, when the temperature of the refrigerant at point A in FIG. 2, or more specifically, a temperature TS of the refrigerant at the inlet port in the compressor 10, is much higher than the saturation temperature of the refrigerant, the compressor 10 is heated. In other words, an extra degree of superheat SH can heat the compressor 10 and thus increase the power consumption of the air conditioner 2.

The degree of superheat SH refers to a temperature rise of the refrigerant from the saturation temperature. The refrigerant is usually converted to a superheated vapor at the outlet of the evaporator. In this case, the degree of superheat SH matches a temperature TSH defined by Formula 1, where the temperature of the refrigerant at the inlet port in the compressor 10 is T_{S}, and the temperature of the refrigerant flowing through the tubes in the outdoor heat exchanger 40, or more specifically, the refrigerant temperature in the evaporator, is T_{E}. In the superheat control process described below, the refrigerant is a superheated vapor at the outlet of the evaporator. The degree of superheat SH thus refers to the temperature calculated with Formula 1.

$${T}_{S H} = {T}_{S} - {T}_{E} \qquad ( 1 )$$

In this manner, a high degree of superheat SH can increase power [0026] consumption of the air conditioner 2. As suggested by this, a low degree of superheat SH can reduce power consumption of the air conditioner 2. A power saving system 1 uses this phenomenon for power saving. More specifically, the power saving system 1 reduces power consumption of the air conditioner 2 using SH control for causing the degree of superheat SH to be 0° C.

The structure of the power saving system 1 is now described with reference to FIGS. 1 and 3 to 7.

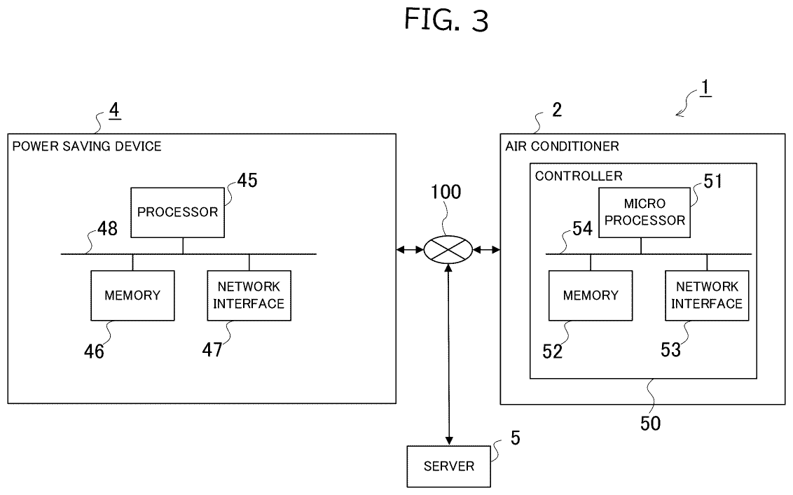

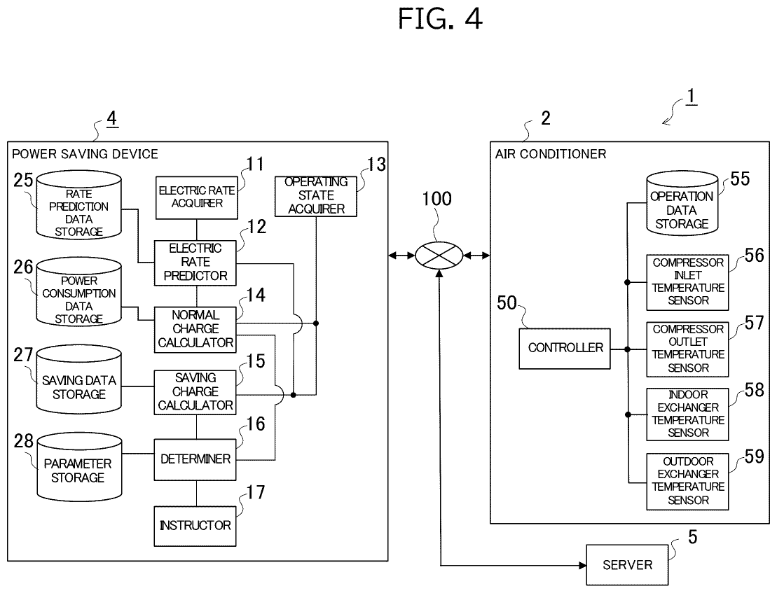

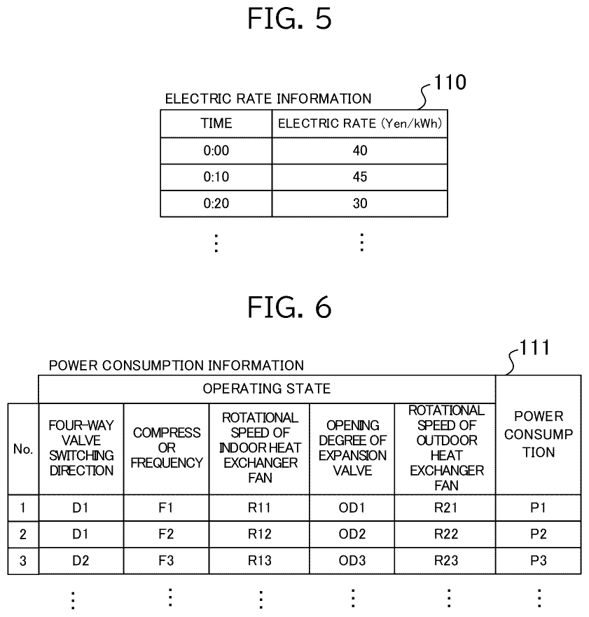

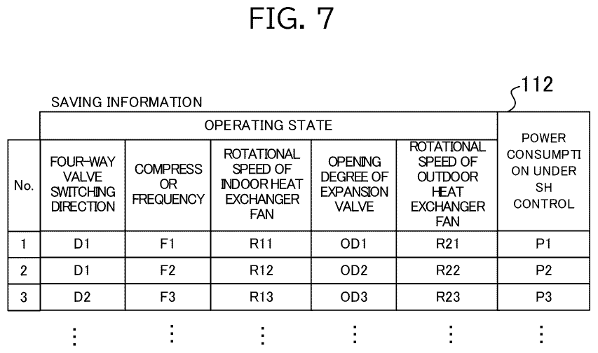

FIG. 3 is a diagram of the power saving system 1 according to the embodiment of the present disclosure, illustrating the hardware configuration. FIG. 4 is a block diagram of the power saving system 1. FIG. 5 is a table of an example of electric rate information 110 used in the power saving system 1. FIG. 6 is a table of an example of power consumption information 111 used in the power saving system 1. FIG. 7 is a table of an example of saving information 112 used in the power saving system 1. For ease of understanding, FIGS. 3 and 4 also illustrate a server 5 of an electric utility connected with a network 100.

As illustrated in FIG. 3, the power saving system 1 includes the air conditioner 2 and a power saving device 4 that causes the air conditioner 2 to perform a power saving operation.

The air conditioner 2 includes the controller 50 to control the operations of the four-way valve, the compressor 10, the fan 21 for the indoor heat exchanger 20, the expansion valve 30, and the fan 41 for the outdoor heat exchanger 40. The controller 50 includes a microprocessor 51, a memory 52, and a network interface 53. The microprocessor 51, the memory 52, and the network interface 53 are connected to one another with a bus 54.

The memory 52 includes an operation data storage 55 illustrated in FIG. 4. The memory 52 stores various programs to control the components in the air conditioner 2, such as an operation program or a superheat control program.

The network interface 53 connects the microprocessor 51 to various sensors illustrated in FIG. 4. More specifically, the network interface 53 connects the microprocessor 51 to a compressor inlet temperature sensor 56 at the refrigerant inlet port in the compressor 10 illustrated in FIG. 1, a compressor outlet temperature sensor 57 at the refrigerant outlet port in the compressor 10, an indoor exchanger temperature sensor 58 in a tube in the indoor heat exchanger 20, and an outdoor exchanger temperature sensor 59 in a tube in the outdoor heat exchanger 40. Thus, the microprocessor 51 acquires the refrigerant temperature data detected by the compressor inlet temperature sensor 56, the compressor outlet temperature sensor 57, the indoor exchanger temperature sensor 58, and the outdoor exchanger temperature sensor 59.

Referring back to FIG. 3, the microprocessor 51 executes the above operation program to control the operations of the four-way valve, the compressor 10, the fan 21 for the indoor heat exchanger 20, the expansion valve 30, and the fan 41 for the outdoor heat exchanger 40. For example, the microprocessor 51 controls the four-way valve, the compressor 10, the fan 21 for the indoor heat exchanger 20, the expansion valve 30, and the fan 41 for the outdoor heat exchanger 40 using the refrigerant temperature data acquired from the various sensors. The microprocessor 51 thus performs a series of steps in SH control to cause the degree of superheat SH to be 0° C. The series of steps in SH control are hereafter referred to as a superheat control process.

The microprocessor 51 and the memory 52 are connected to the power saving device 4 by the network interface 53 through the network 100, or for example, through the Internet, to acquire an instruction as to whether to perform the superheat control process. The microprocessor 51 and the memory 52 can thus communicate with the power saving device 4.

The power saving device 4 includes a processor 45, a memory 46, and a network interface 47. The processor 45, the memory 46, and the network interface 47 are connected with a bus 48, as in the controller 50.

The network interface 47 connects the processor 45 and the memory 46 to an external device, such as the controller 50 in the air conditioner 2 or the server 5 of an electric utility through the network 100. The network interface 47 can thus communicate with the controller 50 in the air conditioner 2 or the server 5.

The processor 45 and the memory 46 form a computer. The memory 46 includes various storages for the power saving process. More specifically, the memory 46 includes a rate prediction data storage 25, a power consumption data storage 26, a saving data storage 27, and a parameter storage 28 illustrated in FIG. 4. The power saving process is a process for determining whether power saving is effective and outputting, when power saving is determined to be effective, an instruction of performing the superheat control process. The memory 46 stores a power saving program for performing the power saving process.

The power saving device 4 performs the power saving process by the processor 45 reading and executing the power saving program stored in the memory 46. To perform the power saving process, the power saving device 4 includes functional blocks as software illustrated in FIG. 4. More specifically, the power saving device 4 includes an electric rate acquirer 11, an electric rate predictor 12, an operating state acquirer 13, a normal charge calculator 14, a saving charge calculator 15, a determiner 16, and an instructor 17.

The electric utility business uses demand response (DR) that changes the pattern of electricity demand by increasing or decreasing the electric rate. The server 5 is a terminal operated by an electric utility. The server 5 transmits information indicating a change in an electric rate resulting from DR to clients, or for example, consumers or renewable energy companies. For example, the server 5 transmits, to the clients, the electric rate information 110 illustrated in FIG. 5 including the time for electricity demand and the electric rate per kilowatt in a manner associated with each other. The electric rate acquirer 11 illustrated in FIG. 4 acquires the electric rate information 110 by receiving the electric rate information 110 through the network 100. The electric rate acquirer 11 transmits the acquired electric rate information 110 to the electric rate predictor 12.

The electric rate predictor 12 predicts a long-term electric rate in a future more distant than the future included in the electric rate information 110. When receiving the electric rate information 110, the electric rate predictor 12 predicts the trend of the electric rate for the prediction period from the current time using an electric rate prediction model.

More specifically, the rate prediction data storage 25 illustrated in FIG. 4 stores data of a trained prediction model generated by causing a neural network to learn many pieces of electric rate information 110 acquired in the past. More specifically, the rate prediction data storage 25 stores data of a trained prediction model generated by causing a neural network to learn, as training data, the relationship between the trend of the electric rate for a predetermined period before a specific time and the trend of the electric rate for a period similar to the prediction period after the specific time. For example, the rate prediction data storage 25 stores weight data of a connection between nodes in the neural network and node data about the neural network. The electric rate predictor 12 reads data of the trained prediction model from the rate prediction data storage 25 and builds the trained prediction model from the data. The electric rate predictor 12 inputs the electric rate information 110 acquired from the electric rate acquirer 11 into the built trained prediction model and predicts the trend of the electric rate for the prediction period from the current time. The electric rate predictor 12 transmits data indicating the predicted trend of the electric rate to the normal charge calculator 14 and the saving charge calculator 15.

The operating state acquirer 13 acquires data for predicting power consumption of the air conditioner 2. The operating state acquirer 13 acquires operating state data of each component in the air conditioner 2 from the controller 50 in the air conditioner 2 through the network 100.

More specifically, the air conditioner 2 stores, in the operation data storage 55, the operating state data for each control operation performed by the controller 50. More specifically, the operating state data is information indicating the operating state of each component, such as the switching direction of the four-way valve, the frequency of the compressor 10, the rotational speed of the fan 21 for the indoor heat exchanger 20, the degree of opening of the expansion valve 30, and the rotational speed of the fan 41 for the outdoor heat exchanger 40. The operating state acquirer 13 causes the controller 50 to read the operating state data of each component from the operation data storage 55 and transmit the read operating state data. The operating state acquirer 13 thus acquires the operating state data of the air conditioner 2. The operating state acquirer 13 transmits the acquired operating state data to the normal charge calculator 14 and the saving charge calculator 15.

The normal charge calculator 14 calculates the electric charge with no power saving. The power consumption data storage 26 stores the power consumption information 111 illustrated in FIG. 6 acquired through experiments. The power consumption information 111 includes the power consumption in a manner associated with the operating state data of each component acquired by the operating state acquirer 13, such as the switching direction of the four-way valve, the frequency of the compressor 10, the rotational speed of the fan 21 for the indoor heat exchanger 20, the degree of opening of the expansion valve 30, or the rotational speed of the fan 41 for the outdoor heat exchanger 40. When receiving the operating state data from the operating state acquirer 13, the normal charge calculator 14 illustrated in FIG. 4 reads the power consumption information 111 from the power consumption data storage 26.

The normal charge calculator 14 determines, among pieces of operating state data included in the read power consumption information 111, a piece of operating state data that matches with or approximates to the received piece of the operating state data. The normal charge calculator 14 then calculates, based on the power consumption data associated with the piece of the operating state data determined as matching with or approximating to the received piece, the power consumption of the air conditioner 2 operating in the state indicated by the received operating state data. More specifically, the normal charge calculator 14 predicts power consumption.

The normal charge calculator 14 further receives data indicating the trend of the electric rate from the electric rate predictor 12 and calculates, based on the received data indicating the trend of the electric rate and the predicted power consumption, the charge for the air conditioner 2 operated in the state indicated by the operating state data for a prediction period from the current time. The charge is hereafter referred to as a normal charge. The normal charge calculator 14 transmits data indicating the calculated normal charge to the determiner 16.

In contrast, the saving charge calculator 15 calculates the electric charge with power saving. The saving data storage 27 stores the saving information 112 illustrated in FIG. 7 acquired through experiments. The saving information 112 includes the power consumption for the operating state of each component switched to the SH control, or more specifically, the power consumption during power saving, in a manner associated with the operating state data of each component specified with, for example, the switching direction of the four-way valve, the frequency of the compressor 10, the rotational speed of the fan 21 for the indoor heat exchanger 20, the degree of opening of the expansion valve 30, and the rotational speed of the fan 41 for the outdoor heat exchanger 40. After receiving the operating state data from the operating state acquirer 13, the saving charge calculator 15 illustrated in FIG. 4 reads the saving information 112 from the saving data storage 27 and determines, among pieces of operating state data included in the read saving information 112, a piece of operating state data that matches with or approximates to the received piece of the operating state data. The saving charge calculator 15 predicts, based on the power consumption during power saving associated with the piece of operating state data determined as matching with or approximating to the received piece, the power consumption of the air conditioner 2 switching from the operating state indicated by the received piece of operating state data to the power saving mode.

Similarly to the normal charge calculator 14, the saving charge calculator 15 receives data indicating the trend of the electric rate from the electric rate predictor 12 and calculates, based on the received data indicating the trend of the electric rate and the predicted power consumption during power saving, the saving charge for the air conditioner 2 operated in the power saving mode for a prediction period from the current time. The saving charge calculator 15 then transmits the calculated saving charge data to the determiner 16.

When receiving the normal charge data from the normal charge calculator 14 and the saving charge data from the saving charge calculator 15, the determiner 16 subtracts the saving charge from the normal charge to calculate the amount reduced by power saving. The parameter storage 28 stores data indicating a set amount that is a threshold to determine whether to perform SH control, or in other words, whether to perform the power saving operation. The determiner 16 reads data indicating the set amount from the parameter storage 28 and determines whether the amount reduced by power saving exceeds the set amount. The determiner 16 thus determines whether to perform the power saving operation.

When the determiner 16 determines that the amount reduced by power saving exceeds the set amount and the power saving operation is thus to be performed, the instructor 17 transmits a saving instruction signal to the controller 50 in the air conditioner 2. The instructor 17 thus causes the controller 50 in the air conditioner 2 to perform the power saving operation, or more specifically, the SH control. The air conditioner 2 is thus operated in the power saving mode using less power, thus reducing electric charge.

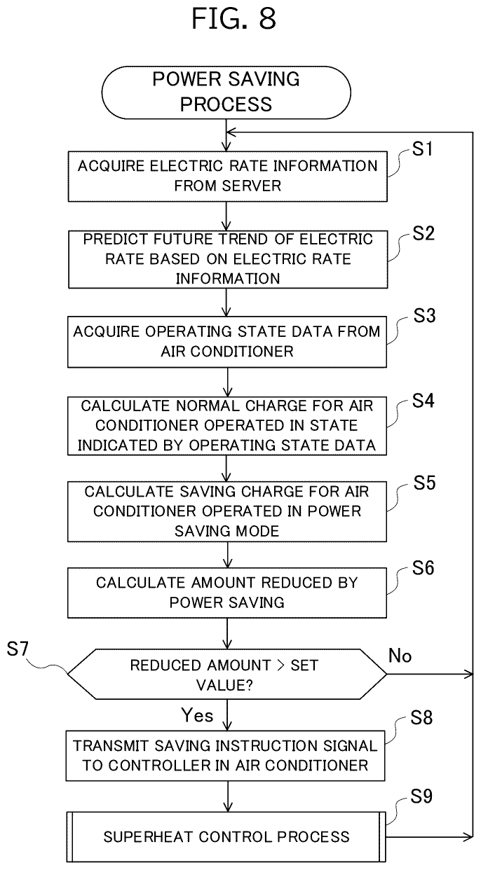

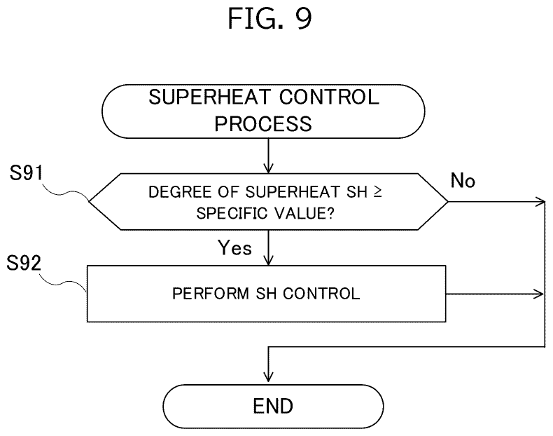

The operations of the power saving system 1, the power saving device 4, and the controller 50 in the air conditioner 2 are now described with reference to FIGS. 8 and 9. In the example described below, the power saving device 4 is activated when a non-illustrated activation switch of the power saving device 4 is pressed. The air conditioner 2 is activated when a non-illustrated power button of the air conditioner 2 is pressed. The activated air conditioner 2 performs the heating operation after automatic selection between the cooling operation and the heating operation.

FIG. 8 is a flowchart of a power saving process performed by the power saving device 4. FIG. 9 is a flowchart of a superheat control process performed by the controller 50 in the air conditioner 2.

When the power saving device 4 and the air conditioner 2 are activated with operations on the activation switch and the power button, which are not illustrated, the processor 45 included in the power saving device 4 executes the power saving program to start the power saving process illustrated in FIG. 8.

As illustrated in FIG. 8, the power saving device 4 first acquires the electric rate information 110 from the server 5 (step S1). For example, the power saving device 4 acquires the electric rate information 110 including the trend of the electric rate in one hour from the current time.

The power saving device 4 then predicts a future trend of the electric rate based on the electric rate information 110 (step S2). As described above, the power saving device 4 reads data of a trained prediction model from the rate prediction data storage 25 illustrated in FIG. 4 and builds the trained prediction model from the data. The power saving device 4 inputs the electric rate information 110 acquired in step S1 into the built trained prediction model to predict the trend of the electric rate for a prediction period, or for example, 24 or 48 hours from the current time.

Subsequently, the power saving device 4 acquires the operating state data from the air conditioner 2 (step S3). The power saving device 4 acquires, from the controller 50 in the air conditioner 2, the operating state data of each component, such as the switching direction of the four-way valve, the frequency of the compressor 10, the rotational speed of the fan 21 for the indoor heat exchanger 20, the degree of opening of the expansion valve 30, and the rotational speed of the fan 41 for the outdoor heat exchanger 40.

The power saving device 4 may acquire, with the controller 50, data indicating the refrigerant temperatures detected by the compressor inlet temperature sensor 56, the compressor outlet temperature sensor 57, the indoor exchanger temperature sensor 58, and the outdoor exchanger temperature sensor 59 illustrated in FIG. 4 to use these pieces of refrigerant temperature data as some pieces of operating state data. These pieces of data may be added to the operating state data to specify the state of the air conditioner 2 more accurately.

Upon acquiring the operating state data, the power saving device 4 calculates the normal charge for the air conditioner 2 operated in the state indicated by the operating state data (step S4). As described above, the power saving device 4 first reads the power consumption information 111 from the power consumption data storage 26 and predicts, using the read power consumption information 111, the power consumption of the air conditioner 2 operated in the states indicated by the operating state data acquired in step S3. The power saving device 4 then calculates the normal charge, or more specifically, the electric charge for the air conditioner 2 operated for a prediction period from the current time at the predicted power consumption when the electric rate changes under the trend predicted in step S2.

The power saving device 4 then calculates the saving charge for the air conditioner 2 operated in the power saving mode (step S5). As described above, the power saving device 4 reads the saving information 112 from the saving data storage 27 and predicts, using the read saving information 112, the power consumption of the air conditioner 2 switching from the state indicated by the operating state data acquired in step S3 to the mode under the SH control. As in step S4, the power saving device 4 calculates the electric charge for the air conditioner 2 operated for a prediction period from the current time at the predicted power consumption when the electric rate changes under the trend predicted in step S2. The power consumption in this state corresponds to the charge for the operation under the SH control, or more specifically, the operation in the power saving mode. Thus, the calculated electric charge is the saving charge in the power saving mode.

The saving charge may be calculated as a charge for the air conditioner 2 operated at the predicted power consumption for the entire prediction period from the current time, but may be calculated as a charge for the air conditioner 2 operated at the predicted power consumption for part of the entire prediction period from the current time, or for example, for a short period such as ten or thirty minutes or one hour. The charge may be calculated as a charge for the air conditioner 2 operated at the predicted power consumption for a limited time period, or for example, the nighttime or the morning, although the calculation of the saving charge is complex. When the air conditioner 2 is operated at the predicted power consumption, or more specifically, in the power saving mode, for such a limited time period, the air-conditioning comfortability is less likely to decrease. Power saving is also achieved in such an operation mode.

After calculating the normal charge and the saving charge, the power saving device 4 calculates the amount reduced by power saving (step S6). More specifically, the power saving device 4 calculates the amount reduced by power saving by subtracting the saving charge from the normal charge.

The power saving device 4 then determines whether the amount reduced by power saving exceeds the set amount (step S7). More specifically, the power saving device 4 reads, from the parameter storage 28, the data indicating the set amount that is a threshold and determines whether the amount reduced by power saving calculated in step S6 exceeds the read set amount.

When determining that the amount reduced by power saving does not exceed the set amount (No in step S7), the power saving device 4 determines that the power saving does not reduce the cost sufficiently and causes the controller 50 in the air conditioner 2 to remain operating in the current operating state. More specifically, the controller 50 does not perform the superheat control process described later.

A predetermined time after determining that the amount reduced by power saving does not exceed the set amount, the power saving device 4 returns to step S1. For example, when the electric rate information 110 acquired in step S1 includes the trend of the electric rate for one hour from the current time, the power saving device 4 returns to step S1 one hour after the determination. When the electric rate information 110 includes the electric rate for every ten minutes, the power saving device 4 returns to step S1 ten minutes after the determination. The power saving device 4 thus acquires the latest electric rate information 110 in step S1 performed for the second time and performs steps S2 to S7 using the latest electric rate information 110. Thus, the power saving device 4 determines whether the power saving can reduce the cost sufficiently using the latest electric rate information 110.

When determining that the amount reduced by power saving exceeds the set amount (Yes in step S7), the power saving device 4 determines that the power saving can reduce the cost sufficiently and transmits a saving instruction signal to the controller 50 in the air conditioner 2 (step S8).

When the power saving device 4 transmits the saving instruction signal to the controller 50 in the air conditioner 2, the controller 50 executes the superheat control program with the microprocessor 51 to perform the superheat control process (step S9).

In the superheat control process, the controller 50 first determines whether the degree of superheat SH illustrated in FIG. 9 is greater than or equal to a specific value (step S91). More specifically, the controller 50 first acquires temperature data measured by the compressor inlet temperature sensor 56 and the outdoor exchanger temperature sensor 59, thus acquiring the refrigerant temperature TS at the inlet port in the compressor 10 and the temperature of the refrigerant flowing through the tubes in the outdoor heat exchanger 40, or more specifically, a refrigerant temperature TE of an evaporator. The controller 50 then calculates the degree of superheat SH from the difference between the temperatures TE and TS. After calculating the degree of superheat SH, the controller 50 determines whether the degree of superheat SH is greater than or equal to the specific value such as, or for example, 1° C. The controller 50 determines whether the SH control cannot be performed with the degree of superheat SH being too close to 0° C.

When determining that the degree of superheat SH is greater than or equal to the specific value (Yes in step S91), the controller 50 determines that the SH control is possible with the degree of superheat SH sufficiently higher than 0° C. The controller 50 then performs the SH control (step S92).

For example, the controller 50 applies model predictive control (MPC) to a linear state-space model of the refrigerating cycle expressed by Formulas 2-1 and 2-2 to perform the SH control.

$${x}_{k + 1} = A \cdot {x}_{k} + B \cdot u \qquad ( 2 - 1 )$$

$${y}_{k} = C \cdot {x}_{k} + D \cdot {u}_{k} \qquad ( 2 - 2 )$$

$$where \\ Δ {T}_{S H} = {T}_{S} - {T}_{E} \\ {x}_{k} is an n - dimentional state vector at time k ( x ∈ {R}^{n} ) \\ {u}_{k} is a two - dimentional input vector at time k u = [ {F}_{c} , {v}_{φ} ] \\ {y}_{k} is a three - dimentional output vector {y}_{k} = [ {T}_{E} , {T}_{C} , Δ {T}_{S H} ]$$

$$A , B , C , and D are constant matrixes ( A ∈ {R}^{n \times n} , B ∈ {R}^{n \times 2} , C ∈ {R}^{3 \times n} , D ∈ {R}^{3 \times 2} )$$

In Formulas 2-1 and 2-2, T_{E} is an evaporator temperature, or more specifically, the temperature of the outdoor heat exchanger 40 measured by the outdoor exchanger temperature sensor 59. T_{C} is a condenser temperature, or more specifically, the temperature of the indoor heat exchanger 20 measured by the indoor exchanger temperature sensor 58. T_{S} is a temperature at the compressor inlet port measured by the compressor inlet temperature sensor 56. F_{C} is the frequency of the compressor, and V_{φ} is the degree of opening of the expansion valve.

The MPC detects an evaporator temperature T_{E,k}, a condenser temperature T_{C,k}, and a temperature T_{S,k} at the compressor inlet port every predetermined time in the refrigerating cycle of the air conditioner 2, and searches for an optimum input u for a period from when each temperature is detected to a horizon time pred, while tracking a reference trajectory y_{sp,k} of an output vector. The MPC sets optimum values for the length of the horizon time pred and the reference trajectory y_{sp,k}, and sets the reference trajectory y_{sp,k} that achieves ΔT_{SH,K}=0Δ within a control period. In this state, the MPC defines the cost function with Formula 3-1 and determines u (k) expressed in Formula 3-2 that minimizes the cost function every predetermined time by, for example, mathematical optimization of quadratic programming (QP).

$$J ( k ) = {\sum }_{j = 1}^{3} {\sum }_{i = 1}^{pred} \vert {\tilde{y}}_{sp , j} ( k + i ) - {y}_{j} ( k + i ) \vert \qquad ( 3 - 1 )$$

$$u ( k ) = {min}_{u} J ( k ) \qquad ( 3 - 2 )$$

$$where \\ reference trajectory is {\tilde{y}}_{sp , k} = [ {T}_{E , k} , {T}_{C , k} , {AT}_{SH , k} ] \\ input vector is u = [ {F}_{C} , {v}_{φ} ]$$

In step S92, the above SH control is performed for a predetermined period. After the SH control is performed for the predetermined period, the superheat control process illustrated in FIG. 9 ends, and the processing returns to step S1 in the power saving process illustrated in FIG. 8.

The predetermined period for the SH control may be the operation time of the air conditioner 2 in the power saving mode used when the saving charge is calculated in step S5. For example, when the saving charge is calculated as a charge for the air conditioner 2 operated in the power saving mode for the entire prediction period from the current time in calculating the saving charge in step S5, the predetermined period for the SH control may correspond to the entire period. When the saving charge is calculated as a charge for the air conditioner 2 operated in the power saving mode for part of the entire prediction period, the predetermined period for the SH control may correspond to the part of the entire period. When the saving charge is calculated as a charge for the air conditioner 2 operated in the power saving mode for a specific time slot in calculating the saving charge in step S5, the SH control may be performed in the specific time slot.

Referring back to FIG. 9, when determining that the degree of superheat SH is less than a specific value (No in step S91), the controller 50 determines that the SH control cannot be performed with the degree of superheat SH being too close to 0° C. The controller 50 thus ends the superheat control process, and then returns to step S1 in the power saving process illustrated in FIG. 8.

The power saving process continues until the power saving device 4 stops upon the non-illustrated activation switch being pressed or the air conditioner 2 stops upon the non-illustrated power button being pressed. The power saving system 1 thus continues power saving for reducing the power consumption of the air conditioner 2 while either the power saving device 4 or the air conditioner 2 is operating.

The SH control performed to cause the degree of superheat SH to be 0° C. refers to the control performed to cause the degree of superheat SH to be within a specific range from 0° C., or for example, within a range of 0° C. to less than 1° C. In other words, the SH control can be a control process to cause the degree of superheat SH to approach 0° C. As is clear from this, the SH control performed to cause the degree of superheat SH to be 0° C. is an example of superheat control to cause superheat to approach 0° C. in an aspect of the present disclosure.

The controller 50 in the air conditioner 2 is an example of an air conditioning controller or an example of a controller in an aspect of the present disclosure. The operation of the air conditioner 2 under SH control is an example of a power saving operation in an aspect of the present disclosure. The power consumption of the air conditioner 2 predicted by the saving charge calculator 15 when the air conditioner 2 is switched to the power saving mode, or in other words, the power consumption predicted in step S5, is an example of saving power-consumption in an aspect of the present disclosure. The power saving device 4 is an example of a control device in an aspect of the present disclosure. The operating state data of each component in the air conditioner 2 is an example of operating state information of each component in the air conditioner in an aspect of the present disclosure. Steps S1, S2, S3, S4, and S5 are examples of acquiring information indicating an electric rate, predicting a trend of an electric rate, acquiring, with a computer, information indicating an operating state of each component in the air conditioner, calculating a normal charge, and calculating a saving charge in an aspect of the present disclosure. Steps S6 and S7 are examples of calculating an amount reduced by power saving and determining that a power saving operation is to be performed when the calculated amount exceeds a set amount in an aspect of the present disclosure. Steps S8 and S9 are examples of instructing, with the computer, the controller to operate each component in the air conditioner in the power saving mode in an aspect of the present disclosure.

As described above, in the power saving system 1 and the power saving device 4 according to the embodiment, the electric rate predictor 12 predicts the trend of the electric rate for the prediction period from the current time, and the normal charge calculator 14 and the saving charge calculator 15 calculate the normal charge and the saving charge based on the predicted trend of the electric rate. The determiner 16 calculates the amount reduced by power saving based on the calculated normal charge and saving charge and determines, when the calculated amount exceeds the set amount, that the power saving operation is to be performed, or more specifically, determines that the SH control is to be performed. The power saving system 1 and the power saving device 4 can thus effectively save power when the electric rate changes based on the demand for electricity by determining whether the amount reduced by power saving exceeds the set amount. The power saving system 1 and the power saving device 4 can thus manage power saving sufficiently.

### Modifications

In the embodiment, when the normal charge calculator 14 acquires the operating state data from the operating state acquirer 13, the normal charge calculator 14 calculates the normal charge for the air conditioner 2 operated in the state indicated by the operating state data, but may predict the operating state data for a prediction period from the current time based on the operating state data acquired from the operating state acquirer 13. In this case, the normal charge calculator 14 may be, for example, an operating state predictive model based on a neural network trained with training data including the trend of the operating state of the air conditioner 2. The normal charge calculator 14 may calculate the normal charge for a prediction period from the current time using the predicted operating state data for the prediction period from the current time. This structure can save power more effectively.

In the embodiment, the SH control includes modeling the refrigerating cycle of the air conditioner 2 using a linear, time-invariant state-space model and controlling the refrigerating cycle with the MPC. However, the controller 50 may perform the SH control using a non-linear state-space model.

The power saving system 1, the power saving device 4, the method for controlling the air conditioner 2, and the program according to one or more embodiments of the present disclosure have been described, but are not limited to the described structure or steps.

For example, in the embodiment, the power saving device 4 includes the electric rate acquirer 11, the electric rate predictor 12, the operating state acquirer 13, the normal charge calculator 14, the saving charge calculator 15, the determiner 16, and the instructor 17, but is not limited to this structure. The power saving device 4 may be any device that include at least the electric rate acquirer 11, the electric rate predictor 12, the operating state acquirer 13, the normal charge calculator 14, the saving charge calculator 15, the determiner 16, and the instructor 17. The power saving device 4 including these components may further include another component.

For example, when a company holding the power saving system 1, the power saving device 4, and the program contracts with an electric utility operating the server 5 for negawatt trading, the power saving system 1 and the power saving device 4 may further include a negawatt trading predictor. In this case, the negawatt trading predictor may predict, based on the electric rate for the predetermined period acquired by the electric rate acquirer 11, whether negawatt trading starts within a prediction period from the current time, and predict, when the negawatt trading starts, the start time and the end time of the negawatt trading. When the negawatt trading predictor predicts that the negawatt trading starts and predicts the start time and the end time, the determiner 16 may determine that the power saving operation is to be performed from after the start time to the end time, or more specifically, may determine that the operation of the air conditioner 2 is to be performed under the SH control. This structure can effectively save power during negawatt trading.

The air conditioner 2 may include a sensor that detects the position of any person around the air conditioner 2 and a wind direction deflector that deflects the wind direction. In this case, the air conditioner 2 may include an actuator that changes, when receiving a saving instruction signal, the orientation of the wind direction deflector to direct the wind toward the position of the person detected by the sensor. This structure can blow wind on the person during the power saving operation to enhance the comfortability, although the air conditioner 2 is operating in the power saving mode.

In the embodiment, the controller 50 determines whether the SH control is possible by determining whether the degree of superheat SH is greater than or equal to a specific value, but the controller 50 is not limited to this structure. Although the controller 50 may or may not determine whether the SH control is possible, the controller 50 may determine that the SH control is not possible when, for example, the refrigerant temperature TD at the outlet port in the compressor 10 measured by the compressor outlet temperature sensor 57 is within the set range for protecting the compressor 10. In another example, the controller 50 may determine that the SH control is not possible when the rotational speeds of the fans 21 and 41 are within the set range for protecting the compressor 10.

In the embodiment, the controller 50 in the air conditioner 2 performs the SH control, but the air conditioner 2 is not limited to this structure. For example, the power saving device 4 may have the function of the controller 50 to perform the SH control. In this case, the power saving device 4 may perform the SH control on each component in the air conditioner 2 through the network 100.

In the embodiment, the power saving device 4 is separate from the air conditioner 2 and connected to the air conditioner 2 with the network 100. The power saving device 4 is not limited to this structure. The power saving device 4 may be included in the air conditioner 2. For example, the power saving device 4 may be located in the housing of an indoor device included in the air conditioner 2.

In the embodiment, the operation of the power saving system 1 is described with the air conditioner 2 performing the heating operation, but the operation is also applicable to the air conditioner 2 performing the cooling operation.

In the embodiment, the power saving program and the superheat control program are stored in the memories 46 and 52, but may be stored in a non-transitory computer-readable recording medium such as a flexible disc, a compact disc read-only memory (CD-ROM), a digital versatile disc (DVD), or a magneto-optical (MO) disk, for distribution. The power saving program stored in the non-transitory recording medium may be installed on a computer to implement the electric rate acquirer 11, the electric rate predictor 12, the operating state acquirer 13, the normal charge calculator 14, the saving charge calculator 15, the determiner 16, and the instructor 17 that perform the power saving process. The superheat control program stored in the non-transitory recording medium may be installed on a computer to implement the controller 50 that performs the superheat control process.

The power saving program or the superheat control program may also be stored in a disk device included in a server on a communication network, typically the Internet, and may be, for example, superimposed on a carrier wave to be downloaded.

The power saving program or the superheat control program may be activated and executed while being transferred through a communication network to implement the above power saving process or superheat control process. The power saving program or the superheat control program may be entirely or partially executed on a server while a computer is transmitting and receiving information about the processing through a communication network. This may also implement the above power saving process or superheat control process.

In the system with the power saving process or the superheat control process implementable partially by the operating system (OS) or through cooperation between the

OS and applications, portions executable by applications other than the OS may be stored in a non-transitory recording medium that may be distributed or downloaded. Means for implementing the functions of the power saving device 4 and the controller 50 is not limited to software, and may be partially or entirely implemented by dedicated hardware including a circuit.

As described above, the power saving system 1, the power saving device 4, the method for controlling the air conditioner 2, and the program are not limited to the structure and the steps described in the above embodiments, and may be modified or include replacement in various manners. Various aspects of the present disclosure are described below as appendixes.

(Appendix 1) A power saving system, comprising:
an air conditioner; and
a control device to manage power saving by causing the air conditioner to perform a power saving operation,
wherein the control device includes
   an electric rate acquirer to acquire information indicating an electric rate for a predetermined period including a current time,
   an electric rate predictor to predict, based on the information indicating the electric rate for the predetermined period acquired by the electric rate acquirer, a trend of an electric rate for a prediction period from the current time,
   an operating state acquirer to acquire, from a controller included in the air conditioner, information indicating an operating state of each component included in the air conditioner,
   a normal charge calculator to predict power consumption of the air conditioner based on the information indicating the operating state acquired by the operating state acquirer and calculate, based on the predicted power consumption and the trend of the electric rate predicted by the electric rate predictor, a normal charge for the air conditioner operated in the operating state for the prediction period,
   a saving charge calculator to predict, based on the information indicating the operating state acquired by the operating state acquirer, saving power-consumption for the air conditioner operated in a power saving mode and calculate, based on the predicted saving power-consumption and the trend of the electric rate predicted by the electric rate predictor, a saving charge for the air conditioner operated in the power saving mode for the prediction period,
   a determiner to calculate, based on the normal charge calculated by the normal charge calculator and the saving charge calculated by the saving charge calculator, an amount reduced by power saving and determine, when the calculated amount exceeds a set amount, that the power saving operation is to be performed, and
   an air conditioning controller to operate, when the determiner determines that the power saving operation is to be performed, each component in the air conditioner in the power saving mode.

(Appendix 2) The power saving system according to appendix 1, wherein
the air conditioning controller is the controller included in the air conditioner,
the control device further includes an instructor to transmit a power saving instruction to the controller when the determiner determines that the power saving operation is to be performed, and
the controller determines, when receiving the power saving instruction, whether the power saving operation is possible and causes, when the power saving operation is possible, each component in the air conditioner to operate in the power saving mode.

(Appendix 3) The power saving system according to appendix 2, wherein
the power saving operation is performed through superheat control to cause superheat to approach 0° C.

(Appendix 4) The power saving system according to appendix 2 or 3, wherein
the air conditioner includes
   a sensor to detect a position of a person around the air conditioner,
   a wind direction deflector to deflect a wind direction, and
   an actuator to change, when receiving the power saving instruction, an orientation of the wind direction deflector to direct wind toward the position of the person detected by the sensor.

(Appendix 5) The power saving system according to any one of appendices 1 to 4, wherein
the control device further includes a negawatt trading predictor to predict, based on the electric rate for the predetermined period acquired by the electric rate acquirer, whether negawatt trading starts within the prediction period from the current time and to predict, when the negawatt trading starts, a start time and an end time of the negawatt trading, and
when the negawatt trading predictor predicts that the negawatt trading starts and predicts the start time and the end time, the determiner determines that the power saving operation is to be performed from after the start time to the end time.

(Appendix 6) The power saving system according to any one of appendices 1 to 5, wherein the electric rate predictor predicts the trend of the electric rate for the prediction period from the current time using a trained model that has learned a relationship between a trend of an electric rate in a past time and a trend of an electric rate after the past time.

(Appendix 7) A power saving device for transmitting a power saving instruction to a controller included in an air conditioner to cause the air conditioner to perform a power saving operation, the power saving device comprising:
an electric rate acquirer to acquire information indicating an electric rate for a predetermined period including a current time;
an electric rate predictor to predict, based on the information indicating the electric rate for the predetermined period acquired by the electric rate acquirer, a trend of an electric rate for a prediction period from the current time;
an operating state acquirer to acquire, from the controller included in the air conditioner, information indicating an operating state of each component included in the air conditioner;
a normal charge calculator to predict power consumption of the air conditioner based on the information indicating the operating state acquired by the operating state acquirer and calculate, based on the predicted power consumption and the trend of the electric rate predicted by the electric rate predictor, a normal charge for the air conditioner operated in the operating state for the prediction period;
a saving charge calculator to predict, based on the information indicating the operating state acquired by the operating state acquirer, saving power-consumption for the air conditioner operated in a power saving mode and calculate, based on the predicted saving power-consumption and the trend of the electric rate predicted by the electric rate predictor, a saving charge for the air conditioner operated in the power saving mode for the prediction period;
a determiner to calculate, based on the normal charge calculated by the normal charge calculator and the saving charge calculated by the saving charge calculator, an amount reduced by power saving and determine, when the calculated amount exceeds a set amount, that the power saving operation is to be performed; and
an instructor to transmit the power saving instruction to the controller when the determiner determines that the power saving operation is to be performed.

(Appendix 8) An air conditioner control method, comprising:
acquiring, with a computer to control a controller included in an air conditioner, information indicating an electric rate for a predetermined period including a current time;
predicting, with the computer, a trend of an electric rate for a prediction period from the current time based on the information indicating the electric rate for the predetermined period;
acquiring, with the computer, information indicating an operating state of each component in the air conditioner from the controller included in the air conditioner;
predicting, with the computer, power consumption of the air conditioner based on the acquired information indicating the operating state, and calculating, based on the predicted power consumption and the predicted trend of the electric rate, a normal charge for the air conditioner operated in the operating state for the prediction period;
predicting, with the computer, saving power-consumption for the air conditioner operated in a power saving mode based on the acquired information indicating the operating state, and calculating a saving charge for the air conditioner operated in the power saving mode for the prediction period based on the predicted saving power-consumption and the predicted trend of the electric rate;
calculating, with the computer, an amount reduced by power saving based on the calculated normal charge and the calculated saving charge, and determining that a power saving operation is to be performed when the calculated amount exceeds a set amount; and
instructing, with the computer, the controller to operate each component in the air conditioner in the power saving mode when the power saving operation is determined to be performed.

(Appendix 9) A program executable by a computer to control a controller included in an air conditioner, the program causing the computer to perform operations comprising:
acquiring information indicating an electric rate for a predetermined period including a current time;
predicting a trend of an electric rate for a prediction period from the current time based on the acquired information indicating the electric rate for the predetermined period;
acquiring information indicating an operating state of each component in the air conditioner from the controller included in the air conditioner;
predicting power consumption of the air conditioner based on the acquired information indicating the operating state, and calculating a normal charge for the air conditioner operated in the operating state for the prediction period based on the predicted power consumption and the predicted trend of the electric rate;
predicting saving power-consumption for the air conditioner operated in a power saving mode based on the acquired information indicating the operating state, and calculating a saving charge for the air conditioner operated in the power saving mode for the prediction period based on the predicted saving power-consumption and the predicted trend of the electric rate;
calculating an amount reduced by power saving based on the calculated normal charge and the calculated saving charge, and determining that a power saving operation is to be performed when the calculated amount exceeds a set amount; and
transmitting an instruction to the controller to operate each component in the air conditioner in the power saving mode when the power saving operation is determined to be performed.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-195413, filed on Dec. 7, 2022, the entire disclosure of which is incorporated by reference herein.

### REFERENCE SIGNS LIST

1 Power saving system
2 Air conditioner
3 Refrigerant circuit
4 Power saving device
5 Server
10 Compressor
11 Electric rate acquirer
12 Electric rate predictor
13 Operating state acquirer
14 Normal charge calculator
15 Saving charge calculator
16 Determiner
17 Instructor
20 Indoor heat exchanger
21 Fan
25 Rate prediction data storage
26 Power consumption data storage
27 Saving data storage
28 Parameter storage
30 Expansion valve
40 Outdoor heat exchanger
41 Fan
45 Processor
46 Memory
47 Network interface
48 Bus
50 Controller
51 Microprocessor
52 Memory
53 Network interface
54 Bus
55 Operation data storage
56 Compressor inlet temperature sensor
57 Compressor outlet temperature sensor
58 Indoor exchanger temperature sensor
59 Outdoor exchanger temperature sensor
61 Saturation liquid line
62 Saturation vapor line
100 Network
110 Electric rate information
111 Power consumption information
112 Saving information

1.-9. (canceled)

10. A power saving device for causing an air conditioner to perform a power saving operation, the power saving device comprising:
a processor
to acquire information indicating an electric rate for a predetermined period including a current time,
to predict, based on the acquired information indicating the electric rate for the predetermined period, a trend of an electric rate for a prediction period from the current time,
to acquire, from a controller included in the air conditioner, information indicating an operating state of each component in the air conditioner;
to calculate, based on the predicated trend of the electric rate, a normal charge for the air conditioner operated in the operating state for the prediction period, and
to predict, based on the acquired information indicating the operating state, saving power-consumption for the air conditioner operated in a power saving mode and calculate, based on the predicted saving power-consumption and the predicted trend of the electric rate, a saving charge for the air conditioner operated in the power saving mode for the prediction period.

11. The power saving device according to claim 10, wherein the processor calculates, based on the normal charge and the saving charge, an amount reduced by power saving and determines, when the calculated amount exceeds a set amount, that the power saving operation is to be performed.

12. The power saving device according to claim 11, wherein the processor transmits a power saving instruction to the controller included in the air conditioner when the processor determines that the power saving operation is to be performed.

13. The power saving device according to claim 10, wherein the processor predicts power consumption of the air conditioner based on the acquired information indicating the operating state and calculates, based on the predicted power consumption and the predicted trend of the electric rate, a normal charge for the air conditioner operated in the operating state for the prediction period.

14. A power saving system, comprising:
the power saving device according to claim 11;
the air conditioner; and
an air conditioning controller to operate, when the processor determines that the power saving operation is to be performed, each component in the air conditioner in the power saving mode, wherein
the power saving device manages power saving by causing the air conditioner to perform the power saving operation.

15. The power saving system according to claim 14, wherein
the air conditioning controller is the controller included in the air conditioner,
the processor transmits a power saving instruction to the controller when the processor determines that the power saving operation is to be performed, and
the controller determines, when receiving the power saving instruction, whether the power saving operation is possible and causes, when the power saving operation is possible, each component in the air conditioner to operate in the power saving mode.

16. The power saving device according to claim 11, wherein
the power saving operation is performed through superheat control to cause superheat to approach 0° C.

17. The power saving system according to claim 14, wherein
the air conditioner includes
a sensor to detect a position of a person around the air conditioner,
a wind direction deflector to deflect a wind direction, and
an actuator to change, when receiving a power saving instruction, an orientation of the wind direction deflector to direct wind toward the position of the person detected by the sensor.

18. The power saving device according to claim 10, wherein
the processor predicts, based on the acquired electric rate for the predetermined period, whether negawatt trading starts within the prediction period from the current time and predicts, when the negawatt trading starts, a start time and an end time of the negawatt trading.

19. The power saving device according to claim 18, wherein
when the processor predicts that the negawatt trading starts and predicts the start time and the end time, the processor determines that the power saving operation is to be performed from after the start time to the end time.

20. The power saving device according to claim 10, wherein
the processor predicts the trend of the electric rate for the prediction period from the current time using a trained model that has learned a relationship between a trend of an electric rate in a past time and a trend of an electric rate after the past time.

21. An air conditioner control method, comprising:
acquiring, with a computer to control a controller included in an air conditioner, information indicating an electric rate for a predetermined period including a current time;
predicting, with the computer, a trend of an electric rate for a prediction period from the current time based on the information indicating the electric rate for the predetermined period;
acquiring, with the computer, information indicating an operating state of each component in the air conditioner from the controller included in the air conditioner;
calculating, with the computer, based on the predicted trend of the electric rate, a normal charge for the air conditioner operated in the operating state for the prediction period; and
predicting, with the computer, saving power-consumption for the air conditioner operated in a power saving mode based on the acquired information indicating the operating state, and calculating a saving charge for the air conditioner operated in the power saving mode for the prediction period based on the predicted saving power-consumption and the predicted trend of the electric rate.

22. The air conditioner control method according to claim 21, further comprising:
calculating, with the computer, an amount reduced by power saving based on the calculated normal charge and the calculated saving charge, and determining, with the computer, that a power saving operation is to be performed when the calculated amount exceeds a set amount.

23. The air conditioner control method according to claim 22, further comprising:
instructing, with the computer, the controller to operate each component in the air conditioner in the power saving mode when the power saving operation is determined to be performed.

24. A non-transitory computer-readable recording medium storing a program, the program causing a computer to control a controller included in an air conditioner to perform operations comprising:
acquiring information indicating an electric rate for a predetermined period including a current time;
predicting a trend of an electric rate for a prediction period from the current time based on the acquired information indicating the electric rate for the predetermined period;
acquiring information indicating an operating state of each component in the air conditioner from the controller included in the air conditioner;
calculating a normal charge for the air conditioner operated in the operating state for the prediction period based on the predicted power consumption and the predicted trend of the electric rate; and
predicting saving power-consumption for the air conditioner operated in a power saving mode based on the acquired information indicating the operating state, and calculating a saving charge for the air conditioner operated in the power saving mode for the prediction period based on the predicted saving power-consumption and the predicted trend of the electric rate.

25. The non-transitory computer-readable recording medium according to claim 24, wherein the program further causes the computer to perform operations comprising:
calculating an amount reduced by power saving based on the calculated normal charge and the calculated saving charge, and determining that a power saving operation is to be performed when the calculated amount exceeds a set amount.

26. The non-transitory computer-readable recording medium according to claim 24, wherein the program further causes the computer to perform operations comprising:
transmitting an instruction to the controller to operate each component in the air conditioner in the power saving mode when the power saving operation is determined to be performed.
